(19) United States
(12) Patent Application Publication
(10) Pub. No.: US 2017/0161700 A1
(43) Pub. Date: Jun. 8, 2017

(54) SECURE INTERNET ATM

(71) Applicant: Sampath Bank PLC, Colombo (LK)

(72) Inventors: Mereggnage Ajith Salgado, Kiribathgoda (LK); Nuwan Prebodha Dias Wickramanayake, Nugegoda (LK); Alredz Denver Pereira, Wattala (LK)

(21) Appl. No.: 15/438,837

(22) Filed: Feb. 22, 2017

Related U.S. Application Data
(63) Continuation of application No. 14/152,019, filed on Jan. 10, 2014, now abandoned.

(51) Int. Cl. G06Q 20/10; G06Q 20/40; G06Q 20/38; G07F 19/00; G06Q 40/02

(52) U.S. Cl. CPC G06Q 20/1085; G07F 19/206; G06Q 40/02; G06Q 20/382; G06Q 20/401; G06Q 2220/00

(57) ABSTRACT

A secure system is described to access ATM-enabled financial accounts over the internet so that customers of a financial institution with an ATM-enabled account can perform through the internet many of the transactions provided through a physical ATM without requiring the user to pre-register with the financial institution. The system of the present invention provides access to an ATM-enabled account by receiving a secured internet request from a user. The computing system in response generates an ATM protocol message and passes the message through the ATM network to the user's financial institution. The user's financial institution then processes the ATM protocol message and sends a reply back through the ATM network and system to the user. In various embodiments of the invention, the user's sensitive card data are secured using multilevel encryption protocols, including virtual keypads, physical hardware decryption modules, and other security mechanisms described in more detail herein.

### CROSS-REFERENCE TO RELATED APPLICATIONS

This application is a continuation of U.S. application Ser. No. 14/152,019, filed Jan. 10, 2014, the contents of which are incorporated herein in their entirety by reference.

### FIELD

The present invention relates to a system and method that enables users to securely access their ATM-enabled financial accounts over the internet without the need to pre-register for an online account at a particular financial institution. Upon accessing the user's ATM-enabled financial account with the system and method of the present invention, a user is able to carry out many of the transactions provided through a physical ATM, except for transactions that involve any dispensing or acceptance of physical monetary instruments.

### BACKGROUND

With the popularity of the internet, many financial institutions now offer online banking capabilities. Online banking allows customers to access their ATM-enabled accounts with a particular financial institution with 24/7 convenience from any location with an internet connection. Online banking typically provides a customer with a host of services, including for example: viewing account balances; transferring money between accounts; obtaining transaction records for checking, savings, and credit card amounts; paying bills online; and downloading transaction and financial information to a financial management software package residing on the customer's computer.

Despite the myriad benefits and conveniences of online banking, it has certain limitations. For example, a customer banking online must first set up his online account with his financial institution and must create a username and password specific to the financial institution's website. If the online banking customer has bank accounts at different financial institutions, he must set up different online accounts at each financial institution and must create a username and password for each account. Additionally, some customers of traditional banking are reluctant to use online banking services because many online banking systems are viewed as too complex.

Another major concern about online banking is account security. Some traditional banking customers are fearful of exposing their account information and financial records over the internet. If an unscrupulous person somehow obtained an online user's username and password, the account associated with the username and password could be accessed without the user's permission. Additionally, if online account login information submitted by the user is transmitted through the computing system in an inadequately secured electronic form, it is susceptible to being stolen by hackers. Even though the use of Secure Sockets Layer (SSL) to secure sensitive data is an accepted security feature and is commonly used in current online banking systems, SSL termination still exposes sensitive data as clear text on a server after the SSL decryption has taken place. All too often this decryption occurs on an unprotected server or network appliance outside a financial institution's “secure zone”, in either the network or demilitarized zone (DMZ), where the data is vulnerable not only to internal threat but also to external attack.

Furthermore, one of the most vulnerable locations is the point of interface that is presented to the user. The potential exists for a hacker to secretly install a program on a user's computer that allows the hacker to monitor the user's computer keystrokes without the user's knowledge. By monitoring the user's keyboard strokes, a hacker could steal the user's bank account username and password when the user enters those data into the login fields on the financial institution's website.

In contrast to online banking, a traditional automated teller machine (ATM) provides a physical apparatus through which users have the ability to check their account information and execute many financial transactions. Traditional ATMs use a physical access card (ATM card) and a user-defined personal identification number (PIN) to provide account access.

A typical ATM card includes the card number and the expiration date of the card embossed on the front surface of the card. Almost all ATM cards include either (and sometimes both) a magnetic stripe manufactured into the back surface of the card or an Integrated Circuit to store data that is electronically encoded by the financial institution that issues the card. The organization of data encoded on cards is typically defined by ISO standards. The data is organized on various “tracks” within the stripe or embedded with the chip. Track two data typically contain the primary account number, expiration data for the card, card service code, and other discretionary data for the card, hereafter, collectively with the user's PIN, referred to as “sensitive card data”.

ATMs provide tremendous benefits to both customers and banks and have become commonplace in modern society. For ATM cardholders, ATM machines allow the customer to withdraw or deposit money into an account, check account balances, and transfer money between accounts at the financial institution that issued the ATM card. Additionally, an ATM user can perform many of these transactions from any ATM, including ATMs owned by financial institutions other than the user's own financial institution. Banks prefer customers to use ATMs because electronic transactions are much less expensive for the bank to process than those handled in person by a teller.

Even though ATMs are enormously popular, they do have their drawbacks. Foremost, the ATM cardholder must be physically present at an ATM to perform any one of the above-listed transactions. In addition, the ATM user must present the user's physical card in order to access the ATM.

WO2001061662A2 describes a method by which users can store their ATM-enabled account information and PIN number on a financial institution's servers and then access the ATM-enabled account by logging into the financial institution's website using a username and password. The financial institution's storage of a user's ATM-enabled account information and PIN in the system of WO2001061662A2 creates the potential that this information could be stolen if the servers of the financial institution are compromised.

Consequently there currently exists no practical way for bank customers to conveniently access their account information and perform certain transactions without either first setting up an online banking account with a username and password at a particular bank or by using a physical ATM and presenting a physical ATM card.

Accordingly, a secure system that allows access to ATM-enabled financial accounts over the internet so that banking customers can perform many of the transactions that they are able to carry out at a physical ATM, without the requirement to be physically present at the ATM, would be beneficial.

### SUMMARY

The present invention is a system and method that allows access to ATM-enabled financial accounts over the internet so that customers of a financial institution can view account balances, transfer funds between linked accounts at their financial institution, and perform many of the transactions they can carry out at a physical ATM or a financial institution's online website without the need to physically be present at an ATM or have previously registered an online account with a particular financial institution.

The secure system of the present invention presents an ATM network connected to a financial institution's computing system to which a user can securely connect and enter the user's sensitive card data using an internet-enabled device. During operation, the computing system provides access to an ATM-enabled account by receiving a secured request containing sensitive card data from a user via the user's internet-enabled device. The financial institution's computing system in response to the secured user request generates an ATM protocol message and passes that message to the ATM network. The ATM network switches the transaction to the bank or financial institution that maintains the ATM-enabled account. The issuing bank or financial institution then processes the ATM protocol message, just like an ordinary ATM transaction, and sends a reply back to the computing system through the ATM network. The reply is then converted into an internet protocol message and provided to the user through the financial institution's secure website. In various embodiments of the invention, sensitive card data are secured using multi-level encryption and decryption protocols, including virtual keypads, physical hardware decryption modules, and other security mechanisms described in more detail herein.

### BRIEF DESCRIPTION OF THE DRAWINGS

FIG. 1 provides an overview of the transaction flow between the various components of the invention.

FIG. 2 provides an illustration of an embodiment of the design of the present invention's virtual keypad.

FIG. 3 provides an illustration of an embodiment of the design of the present invention's transaction selection screen.

FIG. 4 is a flowchart illustrating the process by which a user connects to the Secure Internet ATM and receives requested account information.

### DETAILED DESCRIPTION

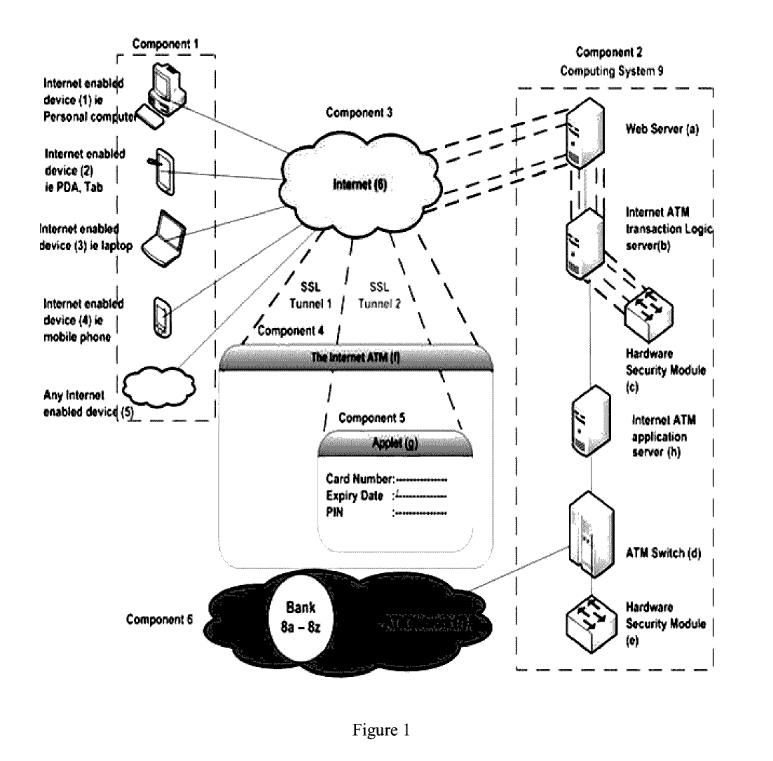

FIG. 1 is a block diagram of the communication infrastructure between the various components of an embodiment of the present invention. This infrastructure includes a computing system (9) that mediates communications between the internet (6) and an ATM network (7). In some embodiments, this computing system (9) is physically located at a financial institution. In other embodiments, this computing system is physically located at another secured location, including but not limited to a secure, off-site data center. Multiple financial institutions such as banks (8a-8z) are connected to the computing system (9) through the ATM network (7). The computing system (9) allows an internet user to access the user's various accounts at one or more financial institutions (8a-8z) using any one of a plurality of internet-enabled computing devices, including but not limited to, a desktop computer (1), a mobile device such as a PDA or a tablet (e.g., iPad) (2), a laptop computer (3), a mobile phone (4), and/or any other internet enabled device (5) that has access to the internet (6) and a browser enabled for SSL encryption. In various embodiments, the desktop computer (1), laptop (3), and/or any internet enabled device (5) can be connected either directly to the internet (6) using a dial-up modem, digital subscriber line (DSL), asymmetric digital subscriber line (ADSL), cable modem, fiber optic interconnect, a wireless service, or through an internet service provider (ISP). Similarly the PDA or tablet (2), mobile phone (4), and/or some other internet enabled device (5) can be connected to the internet through a wireless connection.

In a preferred embodiment, the financial institution's computing system (9) comprises a web server (a) connected to the internet (6), one or more servers, including an Internet ATM application server (h) and ATM transaction logic server (b). Respectively, the Internet ATM application server (h) and ATM transaction logic server (b) contain software that creates the Secure Internet ATM's graphical user interface and transaction logic software that transforms the ATM protocol message to a message that can be read by the user's web browser.

In this same preferred embodiment, the financial institution's computing system (9) further comprises an ATM switch server (d) that connects to the ATM network (7), and two hardware security modules: hardware security module (c), which provides the secure data entry applet (g) and handles decryption of sensitive data and hardware security module (e), which verifies or translates the user's PIN data.

In a still further preferred embodiment, the software that creates the Internet ATM's graphical user interface is similar in function to software used by banks to create their online-banking interfaces. In a preferred embodiment, the software that transforms the ATM protocol message to a message that can be read by a web browser is commercially available software from Thales marketed under the nSheild name. In a preferred embodiment, the servers (a) and (h) are commercially available servers from one or more of Dell, HP, Cisco, and Oracle. In a preferred embodiment, ATM switch (d) is a commercially available product that can be purchased from Interblocks.

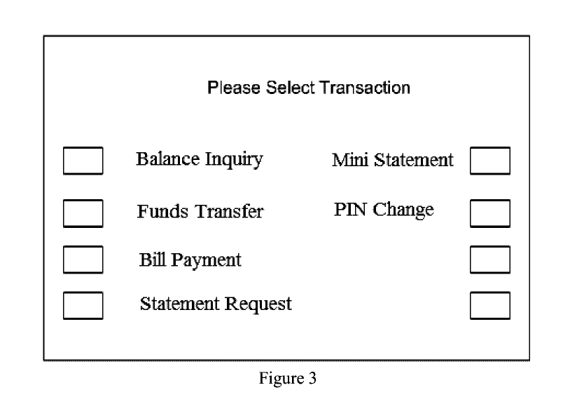

In a preferred embodiment, the financial institution's computing system (9) enables a user to access his or her ATM-enabled account from the user's desktop computer (1), mobile device such as a PDA or a tablet (e.g., iPad) (2), laptop computer (3), mobile phone (4), and/or any other internet enabled device (5). The financial institution's computing system (9) provides internet access to the existing ATM network infrastructure and extends its delivery channels beyond physical ATMs to any internet-enabled device. Specifically, the financial institution's computing system (9) enables card holders of ATM credit or debit cards to, among other things, safely obtain the balance of ATM-enabled deposit and credit accounts, transfer funds between linked accounts and/or third party accounts, pay utility bill payments, top up NFC cards, top up mobile phones, settle credit card bills, transfer mobile cash, function as payment gateways for registered merchants, and change the PIN of the ATM card over the internet and without the need to first perform a user registration or be present at a physical ATM. FIG. 3 provides an illustration of an embodiment of the design of the present invention's transaction selection screen, from which a user can perform these, and other, functions.

### Accessing a User's ATM-Enabled Account Information through the Secure Internet ATM

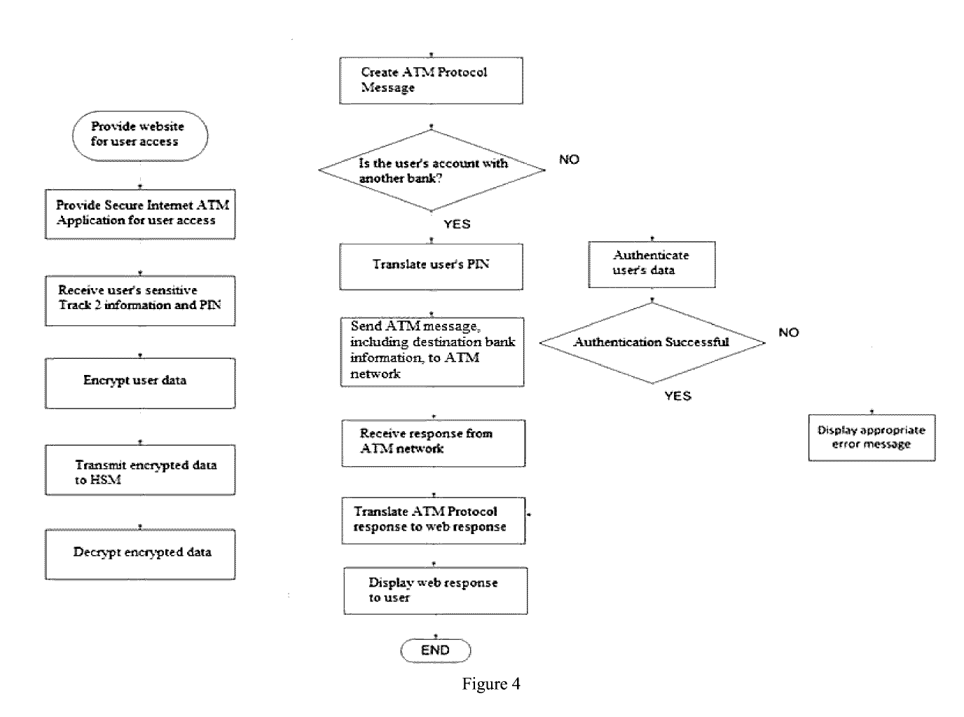

FIG. 4 provides a flowchart that illustrates the process by which a user connects to the Secure Internet ATM and receives requested account information.

In order to securely access a user's ATM-enabled account information and perform certain financial transactions, a user, via his or her internet-enabled computing device, first visits the website of a financial institution utilizing the Secure Internet ATM system of the present invention. In a preferred embodiment, this financial institution's website is hosted on a web server (a). Upon visiting the website of the financial institution, the user navigates his web browser to the Secure Internet ATM webpage on the website of the financial institution using a browser enabled for SSL encryption. The user's browser is connected securely through SSL tunnel 1 to the web server (a) hosting the Secure Internet ATM website. Upon accessing the Secure Internet ATM website, the Internet ATM graphical user interface (f) is presented to the user on the display of his internet enabled device (1)-(5). Once the user has accessed the Secure Internet ATM webpage and has been presented with the Secure Internet ATM graphical user interface (f), the user must enter the user's sensitive card data, including the user's PIN. Unlike data entry done in traditional bank websites, the present invention uses a specialized, secure applet (g) that limits the possibility of hackers to obtain the user's secure card data through key logging software.

More specifically, to present the secure applet (g) to the user, hardware security module (c) creates a separate SSL tunnel 2 within the current SSL tunnel 1 security layer and presents, on the user's display, a secure applet (g) into which the user enters the user's sensitive card data. When an operation is requested that requires the customer's PIN or all or part of Track Two data, the user receives a page with an embedded frame (applet (g)) through SSL tunnel 2, which is terminated on Hardware Security Module (c), into which the user can submit his or her sensitive card data. The function and graphical design of this applet (g) is similar to PIN pad of an ATM. In a preferred embodiment, the software that generates the secure applet is commercially available software from Thales marketed under the nSheild name.

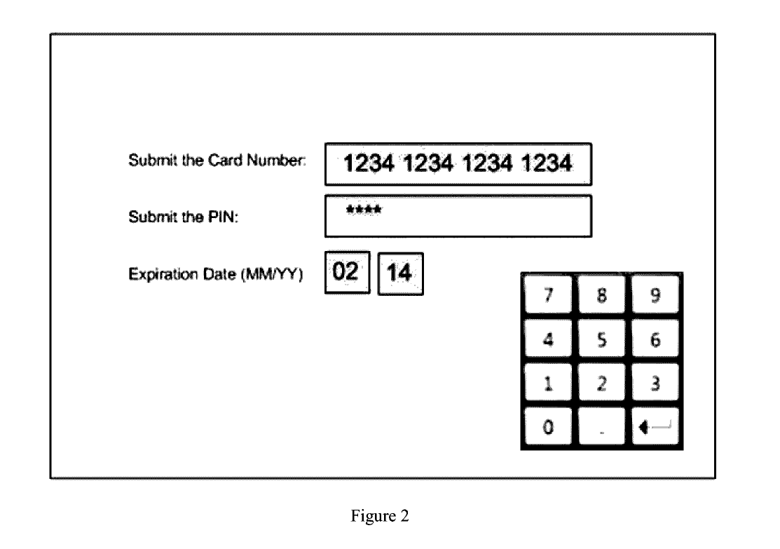

An embodiment of this applet interface is depicted in FIG. 2. The fact that this applet frame is contained within a separate SSL tunnel is not transparent to the user, who only sees submission fields within the Internet ATM webpage and the virtual keypad therein.

To avoid PIN entry via the keyboard (an attack opportunity for key logging software) the PIN selection of the present invention is done via a virtual keypad or through drop-down lists using the mouse, trackpad, trackball, or other device that controls a pointer on the user's display. The entire Track Two information or a portion of the Track Two information is then entered by the user into applet (g). The applet (g) receives the plain text of the sensitive card data and prepares these data for transporting to the ATM switch (d) by encrypting the PIN with a key known to the back-end systems and creating a PIN block. Thereafter, the PIN block plus the card data are encrypted with the Triple Data Encryption Algorithm (3DES) and wrapped is a Secure Sockets Layer (SSL) wrapper. The encryption happens within the applet (g) at the user's device (1, 2, 3, 4, or 5) and the encrypted data are transported via the SSL tunnel 2 to the Secure Internet ATM system's transaction logic server (b) and the Hardware Security Module (c).

After the encrypted sensitive card data are received by the Secure Internet ATM transaction logic server (b) and the Hardware Security Module (c), the data are decrypted and processed into an ATM protocol message. Software commercially available from Interblocks can, in a preferred embodiment, performs the function of processing these data into an ATM protocol message. More specifically, first, the encrypted data and PIN block are first received by the Secure Internet ATM's transaction logic server (b). Then software within the Secure Internet ATM's transaction logic server (b) removes the first SSL wrapper and passes the encrypted data and PIN block to the Hardware Security Module (c). In a preferred embodiment, the software that performs these functions is commercially available software from Thales and marketed under the nSheild brand. The Hardware Security Module (c) then decrypts the sensitive card data and translates the PIN block. The termination of this SSL tunnel 2 happens within the tamper proof confines of the Hardware Security Module (c), within the secure confines of the financial institution's computing system (9) which is preferably located at a physically secured location, which, as stated above, in some embodiments is located at the financial institution itself.

The Hardware security devices (c) and (e) are capable of decrypting and encrypting information in hardware, as opposed to software, and are generally safer than software encryption schemes which are more susceptible to being hacked. In preferred embodiments, the Hardware Security Devices can be commercially purchased from companies such as Thales and SafeNet.

Generally, the only way to access information in a hardware encryption unit is to physically access the internal circuitry of the device. However most of these devices are designed to be tamper-proof, meaning the device becomes inoperable if it is tampered with. Here, the first Hardware Security Module (c) has added functionality where it provided an applet (g) through an SSL layer that is terminated within the hardware security module.

The decrypted data are then forwarded to the ATM network (7). This is accomplished as follows. First, software within the Internet ATM transaction Logic server (b) uses XML or ISO8583 or some propriety format to compile the ATM protocol message which, in part, is based on information received from the user including, but not limited to, the track 2 data. Other data that comprise this message include, but are not limited to, the transaction capture date and time and the acquiring institute ID. This ATM protocol message is then forwarded to the ATM switch (d) and sent to the ATM network much like any transaction captured through a traditional ATM.

Once the transaction is received by the ATM switch (d), a secondary Hardware Security Module (e) is used to validate the PIN or translate it based on the destination of the message. A PIN translation is needed if the user's account is with a financial institution other than the financial institution operating the Secure Internet ATM. If the ATM message is outbound for verification, a PIN translation is generally required.

For accounts with financial institutions other than that of the financial institution operating the Secure Internet ATM, the ATM switch (d) then forwards the message, including the translated PIN, to the ATM network (7). The message, which contains information specifying which bank (8a-8z) it must be sent to within the ATM network, is sent through the ATM network (7) until it reaches the particular bank (8a-8z) at which the user has his ATM-enabled account.

The issuing financial institution then processes the message, verifies the user's PIN, and responds to the user's request via the ATM network (7), which relays the message through the ATM switch (d), and through the Secure Internet ATM server(s) to the user's browser.

In summary, and with reference to FIG. 1, a user's encrypted sensitive card data, which has been entered by the user into the secure applet (g) appearing to the user within the Internet ATM graphical user interface (f), is sent from the user's computing device (component 1) through the internet (component 3), is received and processed by the computing system (component 9) and transmitted to the ATM network (7) and directed and sent to the user's appropriate financial institution (8a-8z). That financial institution then sends a response through the ATM network, through the computing system (9), through the internet (6) to the user's computing device (component 1).

### Security Features of the Present Invention

The present invention allows the card holder to provide all or a portion of the Track Two information of an ATM card to the financial institution's computing system (9) so that this information can be used to access the ATM account. The entire Track Two or a portion of the Track Two information is entered by the card holder each time he wishes to perform a transaction. This information is processed into an ATM protocol message, and this ATM protocol message is then provided to the ATM network (7) each time the ATM account is to be accessed.

Typically, this type of configuration would pose several potential security issues, including: (i) exposure to hackers of the user's Track Two information when the user provides this information to the computing system (9); and (ii) unauthorized access to the all or a portion of the Track Two information if it was stored in the computing system (9).

The present invention uses several measures to eliminate or at least significantly reduce the possibility of either of these events from occurring. In the system of the present invention, the user's Track Two data is not retained on the financial institution's web server or any other server. This helps eliminate the risk of a hacker obtaining the information. Thus, in the present invention, both of the above listed security risks connected with such a transaction of the user's Track Two data have been greatly minimized if not eliminated.

What is claimed is:

1) A system for allowing an internet user to access an ATM-enabled account over an ATM network through the internet, said system comprising:
a. a webserver hosting a bank's website;
b. a server, accessible through said bank's website, hosting software, wherein said server further comprises:
i. software that generates a secure applet for the entry of secure user data on a user's internet-enabled device;
ii. software that receives said secure user data and transmits it to decryption hardware;
iii. decryption hardware that decrypts the secure user data;
iv. software that creates an ATM protocol message from the decrypted user data; and
v. software that transmits the ATM protocol message to an ATM switch;
c. an ATM switch that forwards the ATM protocol message through the ATM network to the ATM-enabled account.

2) The system of claim 1 further comprising hardware that verifies the user's encrypted sensitive card data.

3) A method of providing a user with secure access to an ATM-enabled account through the internet, wherein the user provides only the user's secure card data, comprising:
a. maintaining a computing system that enables a user to access the ATM-enabled account over the ATM network;
b. receiving a request at the computing system from the user seeking to access the ATM-enabled account;
c. providing the user with a virtual keypad from which said user can enter said sensitive card data;
d. encrypting the user's sensitive card data for the ATM-enabled account;
e. receiving at the computing system a user's sensitive encrypted card data for the ATM-enabled account;
f. decrypting the user's sensitive card data for the ATM-enabled account;
g. accessing the ATM-enabled account through the ATM network using the user's sensitive card data;
h. receiving a reply over the ATM network from the financial institution; and
i. forwarding the reply to the user.

4) The method of claim 3 further comprising verifying the user's sensitive card data.

5) A computing system for allowing an internet user to access an ATM-enabled account over an ATM network through the internet, said computing system comprising:
a. a means for receiving a request at the computing system from the user seeking to access the ATM-enabled account;
b. a means for providing the user with a virtual keypad from which said user can enter said sensitive card data;
c. a means for encrypting the user's sensitive card data for the ATM-enabled account;
d. a means for receiving at the computing system a user's sensitive card data for the ATM-enabled account;
e. a means for decrypting the user's sensitive card data for the ATM-enabled account;
f. a means for accessing the ATM-enabled account through the ATM network using the user's sensitive card data;
g. a means for receiving a reply over the ATM network from the financial institution; and
h. a means for forwarding the reply to the user.

6) The system of claim 5 further comprising a means for verifying the user's encrypted sensitive card data.
